(19) United States
(12) Patent Application Publication
(10) Pub. No.: US 2005/0246732 A1
(43) Pub. Date: Nov. 3, 2005

(54) Personal video navigation system

(75) Inventors: Gil Dudkiewicz, San Francisco, CA (US); Yaniv Levi, Foster City, CA (US)

Correspondence Address: FOLEY & LARDNER, 2029 CENTURY PARK EAST, SUITE 3500, LOS ANGELES, CA, 90067, US

(73) Assignee: MyDTV, Inc.

(21) Appl. No.: 11/121,839

(22) Filed: May 2, 2005

Related U.S. Application Data
(60) Provisional application No. 60/567,480, filed on May 2, 2004.

(51) Int. Cl. H04N 5/445; G06F 3/00; H04H 9/00; H04N 7/16

(52) U.S. Cl. 725/13; 725/46; 725/45

(57) ABSTRACT

A navigation system for a video program viewing device generates user interfaces enabling the user to navigate among lists of personalized content, view information about individual content, update user preferences to reflect a preference for a characteristic of a program appearing in a personalized content list, receive personalized alerts regarding upcoming content, manage viewing preferences and configure navigation system options.

### BACKGROUND OF THE INVENTION

1. Field of the Invention

Embodiments of the invention relate to providing on-screen information about television programs to television viewers.

2. Background Technology

In the era of broadcast television and analog cable television, viewers used printed listings to find the times and channels of television programs. Later, cable system operators began to provide channels dedicated to showing program listings. These listings were conventionally referred to as electronic program guides or EPGs. EPGs were typically presented as a passively scrolling grid in which each row showed the current and upcoming programs available on a particular channel. The scrolling grid was generated by a computer program using program guide data supplied by one of a handful of sources such as Tribune Media or TV Guide. While this type of program guide was useful it also had many shortcomings. For example, a viewer who wished to see the listings for a particular channel might be forced to wait several minutes while the guide slowly scrolled through other channels before arriving at the channel of interest. Further, the guide only displayed listings for a narrow window of time, typically 90 minutes, and so a viewer was unable to see listings for a later part of the day.

Subscribers to newer digital television services such as digital cable and satellite television use digital video receiver devices with data processing and storage capabilities. The processing capabilities of these devices has enabled the deployment of enhanced program guide technologies commonly referred to as interactive program guides or IPGs. IPGs present a graphical user interface that the viewer uses to actively navigate through a database of program listings. FIG. 1 shows an example of a conventional interactive program guide. The guide 12 is displayed in the viewing area 10 of a video display device such as a television in response to a display command from a remote control. The guide 12 is typically comprised of a grid 14 in which individual programs 16 are listed by channel 18 and time 20. The user may navigate through the programs in the grid using the keys of the remote control. This typically involves directing the movement of a cursor that highlights the field of the particular program on which it is located (e.g. the program “Business Day” in FIG. 1). By moving the cursor up and down the viewer may scroll through the channels listed in the grid. The guide typically scrolls by a row or a page when the user attempts to go past the top or bottom of the displayed rows, and most guides provide page up and page down functions, operated for example by pressing the channel up or channel down key on the remote control. Similarly, by moving the cursor to the right, the viewer may scroll forward in time to view future program listings. The guide typically shifts by one column or one page when the user attempts to go past the right-most column, and most guides provide page right and page left functions, operated for example by pressing fast forward and rewind keys or other designated keys on the remote control. Some guides also enable the user to scroll backward to listings for programs that have already aired.

When the viewer locates the cursor on the field of a particular program, information about that program is displayed in a program window portion 22 of the guide. This information typically includes the title of the program 24 and a description of the program 26.

The guide may also enable the viewer to take a number of actions with respect to a particular program. For example, the viewer may tune directly to a current program by navigating the cursor to that program and then pressing a select key on the remote control, and may record a current program by navigating the cursor to that program and then pressing a record key. Similarly, for a future program, the viewer may directly schedule actions from the guide such as recording of the program or generation of a reminder when the program is about to air. The guide may also enable the user to update viewing preferences stored in a viewer profile by indicating that the user is interested or disinterested in programs having characteristics similar to those of a program currently highlighted in the guide. Actions such as scheduling and indication of viewer preferences are usually performed using dedicated keys of a remote control.

Interactive program guides also typically provide various customization functions. For example, the specific channels displayed by the guide may be customized from a list of all possible channels. The guide may also be filtered to display only those programs having specified characteristics, such as a specified genre (e.g. sports, news, movie), rating (e.g. children, mature) or other feature such as the availability of closed caption data or alternate language audio.

Another type of interactive feature typically provided by digital video receiver devices is an interactive program banner. FIG. 2 shows an example of a conventional interactive program banner. The banner 28 is typically displayed over the image of the program currently being viewed, and typically includes information about the program including the name and time 30 of the program being viewed and descriptive information 32 about the program being viewed. The program banner is typically displayed upon changing the channel, and may also be displayed in response to user operation of an information key or other key on the remote control.

Television programming distributors must attract viewers in order to sustain their advertising rates, and significant resources are invested in producing and obtaining the right programming content to attract the right viewers. However, as the amount of content grows, viewers are presented with many viewing options. This makes the most desirable content difficult to locate and places limitations on the viewer's ability to access desirable content. Thus both the viewer and the programming distributor are denied an optimal viewing experience.

Efforts are being made to address this problem through personalization technologies that identify programs of interest to the viewer based on viewer-specified viewing preferences or based on the viewer's prior viewing choices. Developers of these technologies continue to seek improvements to the personalization feature set, the accuracy of the personalization process, and the user interface to the personalization technology.

### SUMMARY OF THE INVENTION

Embodiments of the invention provide enhanced personalization technology in the form of a personal video navigation system. The navigation system provides improvements to the personalization feature set, the accuracy of the personalization process, and the user interface to the personalization technology. The navigation system of the preferred embodiment generates user interfaces enabling the user to navigate among lists of personalized content, view information about individual content, update user preferences to reflect a preference for a characteristic of a program appearing in a personalized content list, receive personalized alerts regarding upcoming content, manage viewing preferences and configure navigation system options. The user interface of the preferred embodiment is characterized by a display layout that concentrates personalize content lists, navigation tools, information displays and configuration tools at the borders of the viewing area. The user interface components may be displayed concurrently with video content, allowing the user to use the features of the user interface without unduly disrupting the viewing experience. The user interface components may include an ancillary content portion in which program-related ancillary content such as images, video previews or live video may be displayed, or where other ancillary content such as advertisements may be displayed.

### DESCRIPTION OF THE DRAWINGS

FIG. 1 shows features of a conventional interactive program guide.

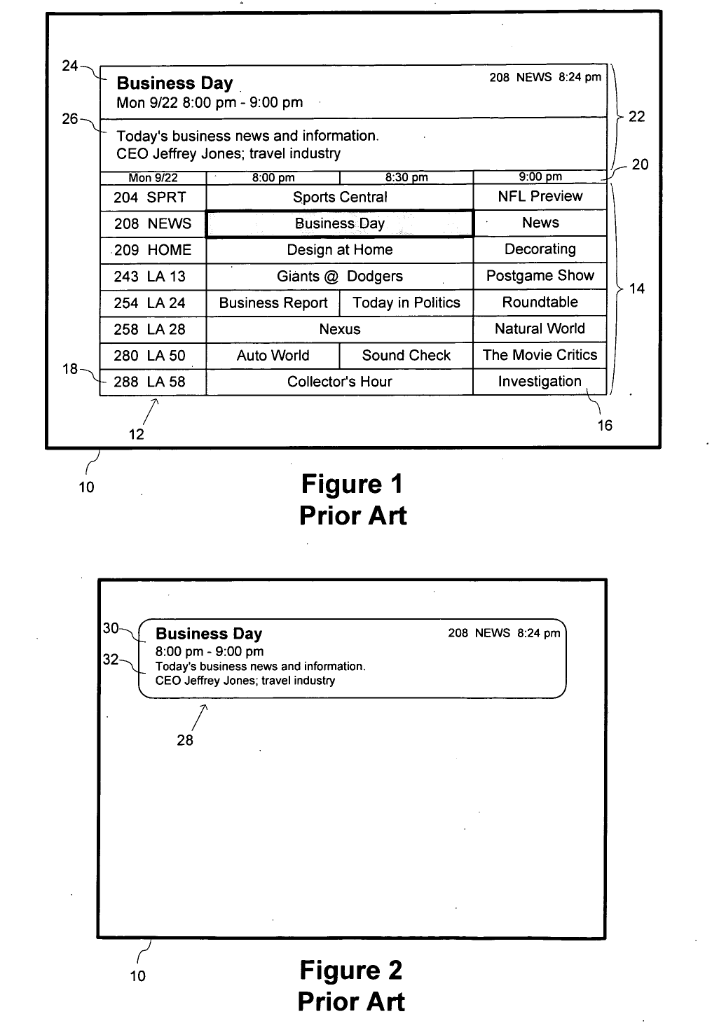

FIG. 2 shows features of a conventional interactive program banner.

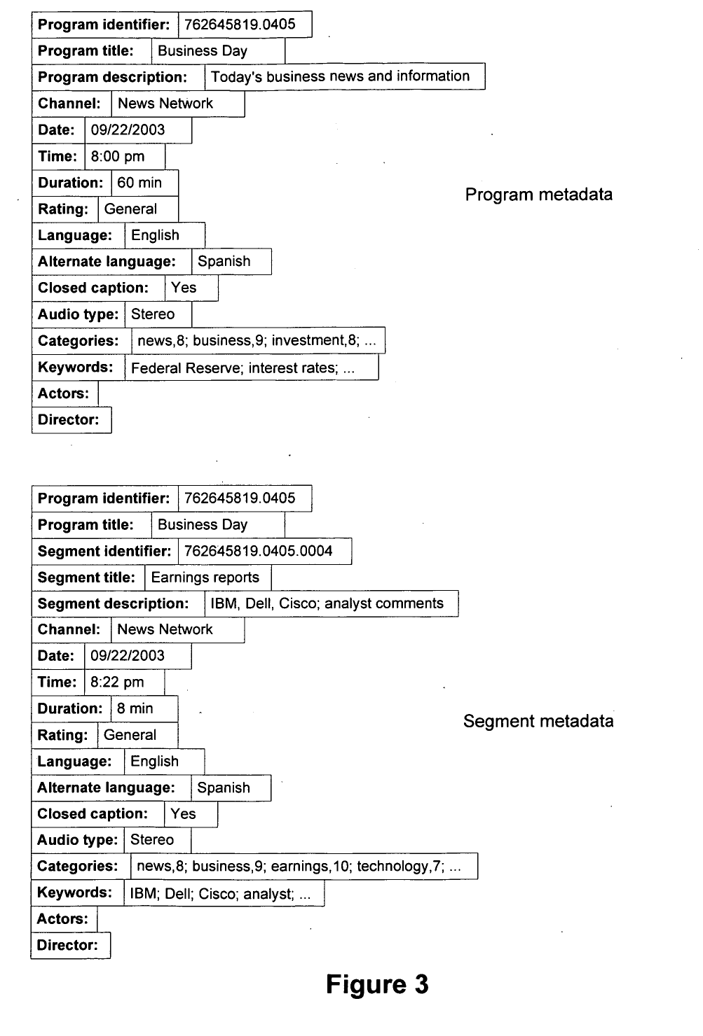

FIG. 3 shows an example of program and program segment metadata.

FIG. 4 shows an exemplary configuration of a metadata creation and distribution system.

FIG. 5 shows an exemplary architecture of a video receiver device in accordance with an implementation of the invention.

FIG. 6 shows a feature set and navigation path for a program information user interface in accordance with the preferred embodiment.

FIG. 7 shows a feature set and navigation path for an alert banner user interface in accordance with the preferred embodiment.

FIG. 8 shows a feature set and navigation path for a personalized content list user interface in accordance with the preferred embodiment.

FIGS. 9 and 10 show an implementation of the alert banner user interface of FIG. 7.

FIGS. 11, 12, 13, 14, 15, 16, 17 and 18 show an implementation of the personalized content list user interface of FIG. 8.

### DETAILED DESCRIPTION OF PREFERRED EMBODIMENTS

For purposes of this disclosure, the following terms and definitions are used:
“segment” and “program segment” refer to a distinct portion of video content (e.g. a television program, movie, etc.) that pertains to a particular subject and in that respect can stand on its own as a complete viewing experience. Examples of segments are individual music videos of a music video program and individual stories within a news broadcast.
“segment metadata” and “program segment metadata” refer to data that includes description of the content of an individual program segment, such as a segment identifier, a title, a content summary, and categories and keywords that describe the subject matter of the segment, and that further includes timing information about the segment such as a start time, an end time, a start time and duration, or references to video frames.

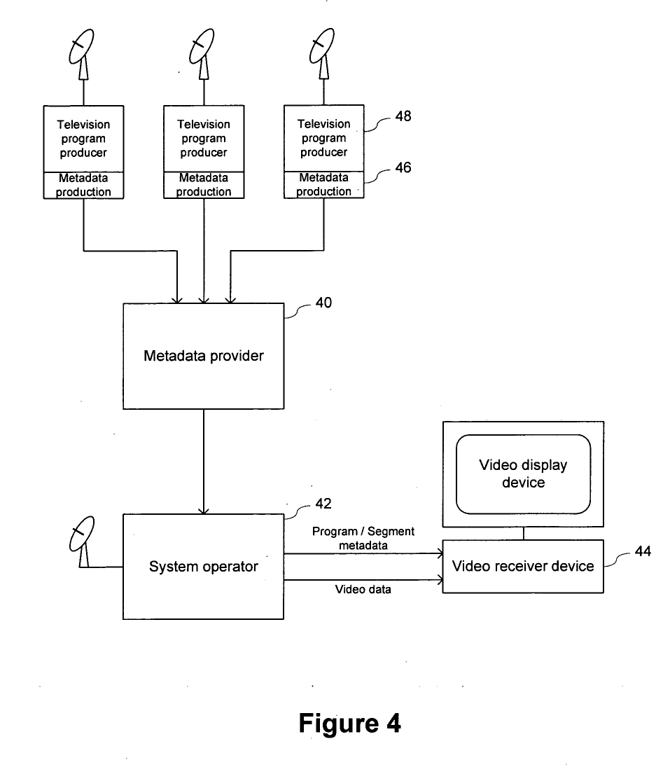

FIG. 3 shows examples of program metadata and segment metadata in accordance with an embodiment of the invention. The program metadata includes a variety of descriptive information concerning a television program, including the program title, a program description, categories and keywords that are descriptive of the subject matter of the program, and actors and directors associated with the program. It is preferred that each category is provided with a corresponding score indicating the goodness of fit of the category to the subject matter of the program. The illustrated program metadata further includes timing information such as the start time and duration of the program. Other program information typically included in the program metadata such as a unique program identifier is also illustrated.

The segment metadata of FIG. 3 is similar to the program metadata, but is distinguished from the program metadata in that it provides content and timing information that is specific to an individual segment of a program rather than to the program as a whole. The illustrated segment metadata includes descriptive information including a segment title, a segment description, categories and keywords that are descriptive of the subject matter of the segment, and actors and directors associated with the segment. The illustrated segment metadata further includes timing information such as the start time and duration of the segment. Other segment information typically included in the segment metadata such as a unique segment identifier is also illustrated.

In the preferred embodiment, program metadata and segment metadata are distinct data objects that have logical relationships through the particular data that they contain. For example, the segment metadata of FIG. 3 is related to the program data of FIG. 3 in that they both reference the same program identifier, program title, channel, and date, and the time of the segment is within the time of the program. Thus it is known that the segment metadata of FIG. 3 describes a segment of the program described by the program metadata of FIG. 3. However in alternative implementations other methods may be used to specify relationships between program metadata and segment metadata objects, or metadata objects may be allowed to contain both program metadata and segment metadata.

Further details regarding the generation and use of program and segment metadata as described above are provided in patent applications owned by the assignee of the present application, including published application US 2002/0092002, published 11 Jun. 2002, which is incorporated herein by reference for its teachings regarding the generation and use of program and segment metadata and for its other teachings referenced herein.

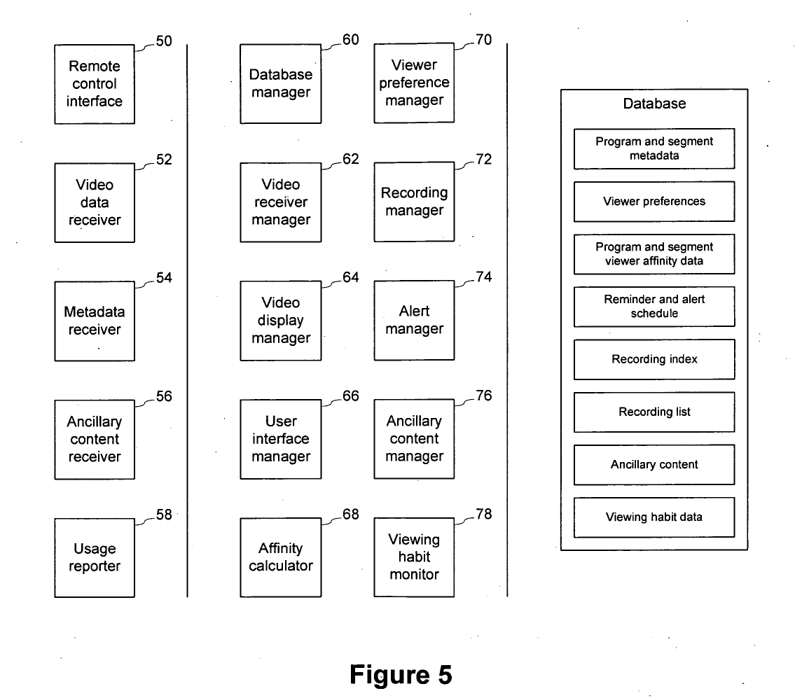

FIG. 4 shows an exemplary system for supplying program and segment metadata to a viewer's video receiver device. Program and segment metadata are preferably supplied by a metadata provider 40 to a system operator 42 such as a cable system operator or satellite television provider. The system operator 42 in turn supplies the metadata to individual video receiver devices 44 such as set top boxes and digital video recorders. In the case of cable and satellite systems, the metadata and other ancillary content is typically supplied through the video data transmission medium as out-of-band data. In other embodiments the video receiver device may obtain metadata in other manners such as through a dial-up, local network or internet connection to the metadata supplier.

The segment metadata supplied by the metadata supplier is preferably produced through the use of production agents 46 that interface directly with the production systems of television program producers 48 to extract production data that is processed to generate program metadata for the programs and to identify individual program segments and generate segment metadata for those segments. A preferred system for producing segment metadata in this manner is MyDTV Inc.'s ContentIQ metadata production system, aspects of which are described in the patent application incorporated above. This type of deployment produces detailed program and segment metadata in a highly automated fashion, and enables just-in-time production and distribution of detailed program metadata and segment metadata for programs whose content is undefined until shortly before or at the time of broadcast, such as news programs and sporting events. Alternative methods of metadata production and distribution may also be employed.

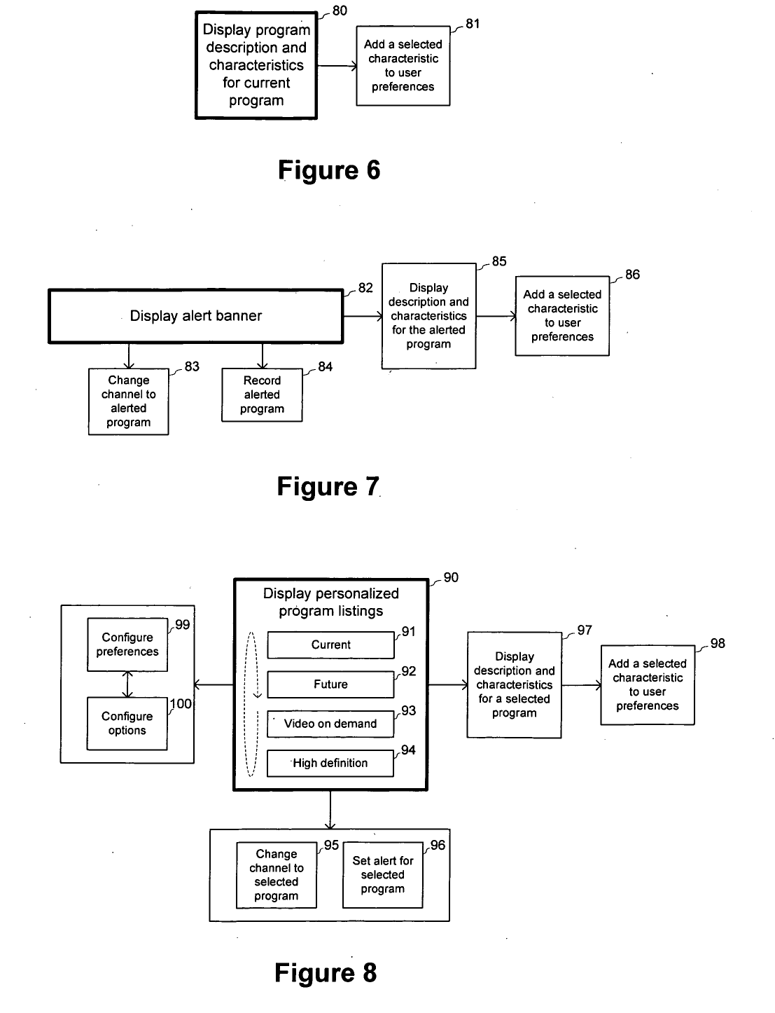

FIG. 5 shows a high level view of the architecture of a video receiver device in accordance with an embodiment of the invention. In general, the devices in which embodiments of the invention are implemented are programmable devices that include a microprocessor, nonvolatile memory storing programming code for controlling the microprocessor and other hardware, rewritable nonvolatile memory such as flash memory for storing configuration data, random access memory for providing a working memory space, a video decoder, a digital signal processor, and one or more communication interfaces for receiving data or signals from, supplying data or signals to or exchanging data or signals with various external systems and devices. The illustrated architecture is typically implemented through combinations of software processes and hardware elements that execute or are controlled by the software processes. These components interact to provide personal video navigation system features and navigation paths such as those of the preferred embodiment described below. The architecture illustrated in FIG. 5 is characteristic of a digital video recorder or home media server that can receive, record and play video content. However, alternative architectures may be implemented on platforms that do not provide recording features such set top boxes, televisions, and other video receiver devices, and on platforms that do not provide video receiver features such as personal computers and personal digital assistants. The differences in the components required for different implementations will be apparent from the chosen platform.

The components of the video receiver architecture of FIG. 5 include interface components that provide interaction with other devices and systems. One interface component is a remote control interface 50 that receives user-generated control signals. The control signals are typically transmitted by an infrared or RF remote control device, but may be transmitted by other types of devices and may be received through another type of interface such as a physical or wireless network interface. A video data receiver 52 receives video data from the system operator, and a metadata receiver 54 receives metadata. An ancillary content receiver 56 receives data for ancillary content to be displayed in the personal video navigation system user interface, such as advertisements, images, and preview videos. A usage reporter 58 reports usage data such as viewing habits, program purchases and other transactions. In some instances multiple interface components will utilize the same interface hardware.

The video receiver architecture of FIG. 5 also includes a number of components for managing various aspects of the device to provide features as described herein. A database manager 60 manages the flow of data into and out of a database. The database contains a variety of data including program and segment metadata, viewer preference data, program and segment affinity data representing a calculated viewer affinity for programs and segments, a reminder and alert schedule, a recording schedule, an index of recorded content, preview and image content for display in the navigation system user interface, and viewing habit data representing viewers' viewing and recording choices.

A video receiver manager 62 controls the video receivers or tuners of the device to select a channel to be tuned to and demodulated for viewing or recording. A video display manager 64 selects video sources such as channels of live signals and previously recorded content as input to a video decoder to produce an output signal for a display device. A user interface manager 66 controls the appearance and operation of graphical user interfaces presented to the user such as program guides, program banners and other user interfaces, examples of which are described below. An affinity calculator 68 calculates a level of viewer affinity for programs, segments and ads based on viewer preferences defined by the viewer and metadata describing the programs, segments and ads. A viewer preference manager 70 receives input that defines the viewer's content preferences and maintains a viewer profile based on such input. The input may be direct viewer input or indirect viewer input such as viewing and recording habits. A recording manager 72 controls the scheduling and recording of video programs and program segments in response to automated and manual recording selections, and an alert manager 74 controls the scheduling of reminders and the automated scheduling of alerts for programs and segments of interest to the viewer. Details concerning the creation of viewer profiles, their use in determining the viewer's affinity for particular content using program and segment metadata, and the automated scheduling of recordings and alerts based on those affinity levels are provided in the patent application incorporated above.

The video receiver architecture of FIG. 5 also includes an ancillary content manager 76 that controls the receipt, storage and display of program-related ancillary content such as images, video previews or live video, and other ancillary content such as advertisements may. Ancillary content is selected for display by the ancillary content manager in response to navigation commands received from the user and may be selected to correspond to a program in the user interface or on another basis.

The video receiver architecture of FIG. 5 also includes a viewing habit monitor 78 that generates and stores data indicating the viewing and recording habits of users of the device. This data may be used for purposes of updating viewer preferences and may be exported as usage data to services for establishing the size and composition of viewing audiences for programs and program segments.

The elements shown in FIG. 5 interact to produce a navigation system that generates user interfaces enabling the user to view lists of personalized content, view information about individual content, receive personalized alerts regarding upcoming content, manage viewing preferences and configure navigation system options. The person of ordinary skill in the art will be capable of selecting hardware and software components and producing programming code to implement the architecture of FIG. 5 or an alternative architecture and thereby provide features including those of the preferred embodiment and alternative embodiments.

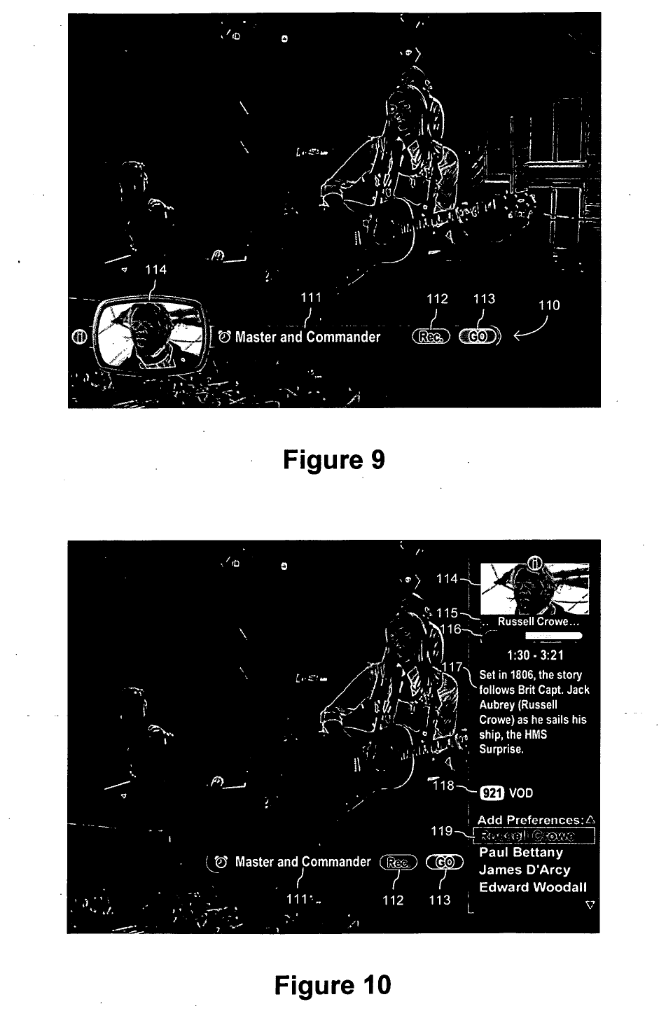

Aspects of a first embodiment of a navigation system are illustrated in FIGS. 6-8, which show features provided by the user interfaces of the navigation system and navigation paths among those features. The commands issued by the user to navigate among and interact with these features are typically generated by operating keys on a remote control device but may be supplied through any input device.

FIG. 6 shows features of a first user interface that responds to a display command by displaying information about a currently viewed program. The user interface initially displays 80 a description of the program and categories and keywords (referred to hereinafter as characteristics) from the metadata of the program. Upon user selection 81 of one of the characteristics, that characteristic is added to the set of characteristics that represent the user's viewing preferences.

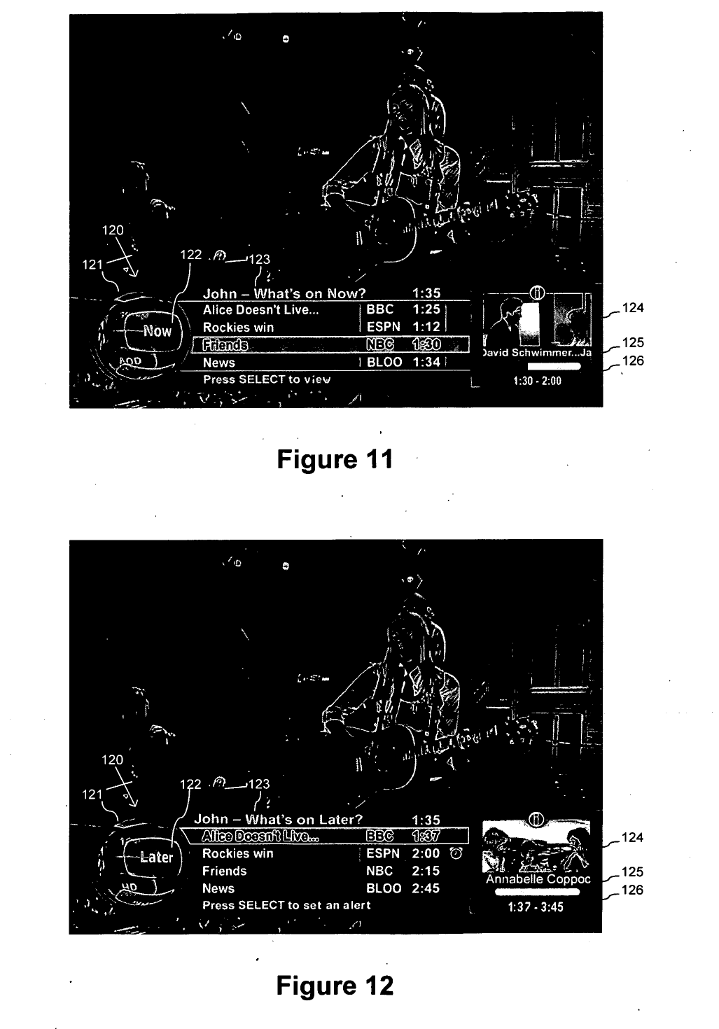

FIG. 7 shows features and paths of a second user interface that is produced to alert the viewer to the availability of a program. The user interface initially displays an alert banner 82 that includes a change channel tool and a record tool. The user may use these tools to change the channel to the content identified in the banner 83, or to record the content identified in the banner 84. The user may also invoke a description feature that provides a description and characteristics of the content identified in the banner 85. Selection of a characteristic adds that characteristic to the user's viewing preferences 86.

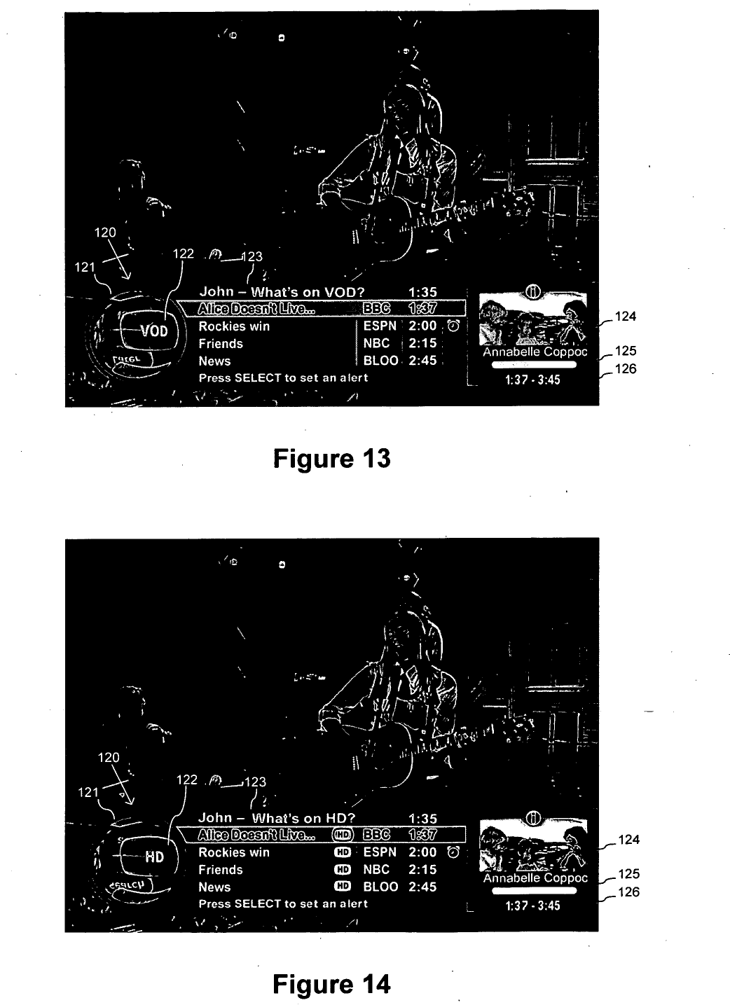

FIG. 8 shows features and paths of a third user interface that displays a list of personalized content to the viewer. The user interface initially displays personalized program listings 90 that are selected for display based on viewing preferences stored in the system. A tool in the user interface allows the user to select among different types of program listings to be displayed, including current programs 91, future programs 92, video on demand programs 93 and high definition programs 94. Selection of a particular program from among the displayed program listings causes the system to change to the channel of the program 95 or set an alert for the program 96, depending on whether the program is a current or a future program. The user may also invoke the display of a program description 97 for a selected program that includes characteristics of the program. Selection of one of the characteristics adds that characteristic to the set of characteristics that represents the user's viewing preferences 98. The user may also navigate to tools for configuring viewing preferences 99 and configuring navigation system options 100.

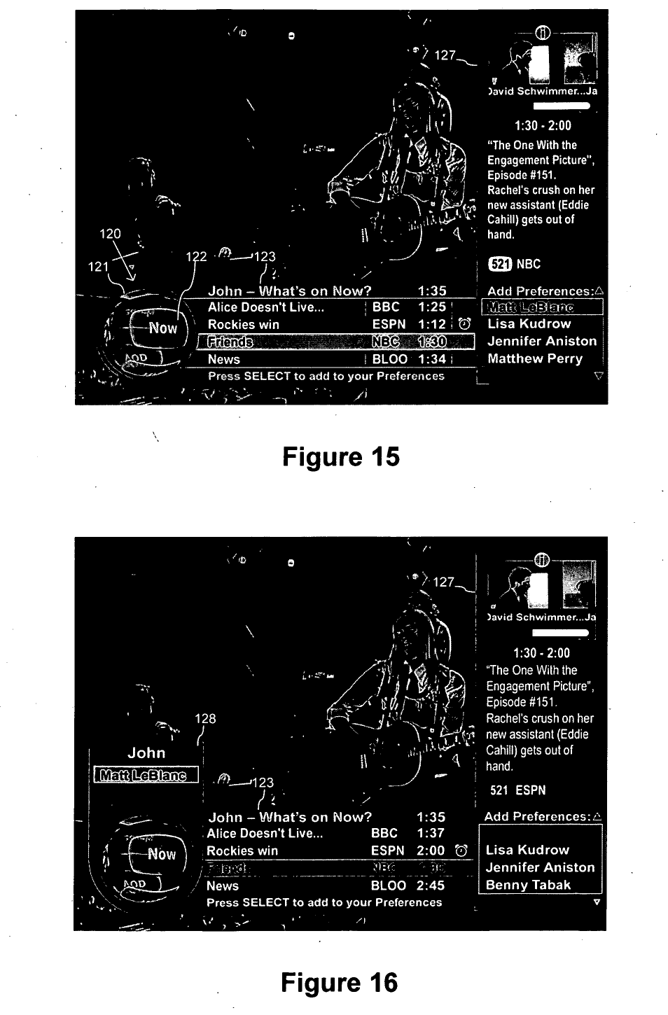

FIGS. 9-17 show examples of user interfaces generated by an exemplary implementation of the navigation system of the preferred embodiment.

FIGS. 9 and 10 show user interfaces providing the feature set and navigation paths of FIG. 7. FIG. 9 shows an alert banner 110 that is displayed over a currently viewed program to alert the viewer of a current or upcoming program that may be of interest to the viewer. The alert banner 110 displays the title of the program 111 and provides a record tool 112 and a go tool 113 that the user may select to record the program or to change to the channel of the program. The user may navigate to the record tool 112 and go tool 113 using directional keys on a remote control and may operate the tools using an enter button on the remote control. Alternative embodiments may provide one or the other of these tools, depending on the platform. The alert banner also includes an ancillary content window 114. The ancillary content window may display various types of content such as an image, a preview video, a live video, an ad, or program information such as the start time, stop time, channel or network of the program listed in the banner. In the preferred embodiment the ancillary content window initially displays an image or video, and then appears to flip over to reveal the start time, stop time, channel and network of the program. Alternative forms of animation may be used to reveal this information, or it may be provided directly on the alert banner without animation.

FIG. 10 shows the alert banner user interface after the user has issued a command to display a description 114 of the program identified in the alert. The command may be issued, for example, by operating a display button of the remote control, or by navigating beyond the position of the go tool 113 using directional keys on the remote control. The new portion of the user interface containing the description includes the ancillary content previously displayed in the alert banner. Beneath the ancillary content window is a crawl 115 that displays characteristics from the metadata of the program in a horizontally crawling fashion. The characteristics included in the crawl 115 may be a subset of characteristics from the program metadata that match characteristics specified in the viewer's preferences. The display further includes a time bar 116 showing the progress (if any) of the program and the start and end time of the program. The display further includes a text description 117 of the program subject matter, and channel and network information 118 for the program. At the bottom of the display is a list of selectable characteristics 119. The user may navigate an indicator among the selectable characteristics 119 using directional keys of the remote control, and may select a characteristic on which the indicator is located using an enter key of the remote control. Selection of one of the characteristics adds that characteristic to the set of characteristics that represents the user's viewing preferences.

The description portion of the display shown in FIG. 10 including the selectable program characteristics may also be invoked by a user independently of an alert banner to provide characteristics of a currently viewed program. This manner of operation implements the features and navigation illustrated in FIG. 6.

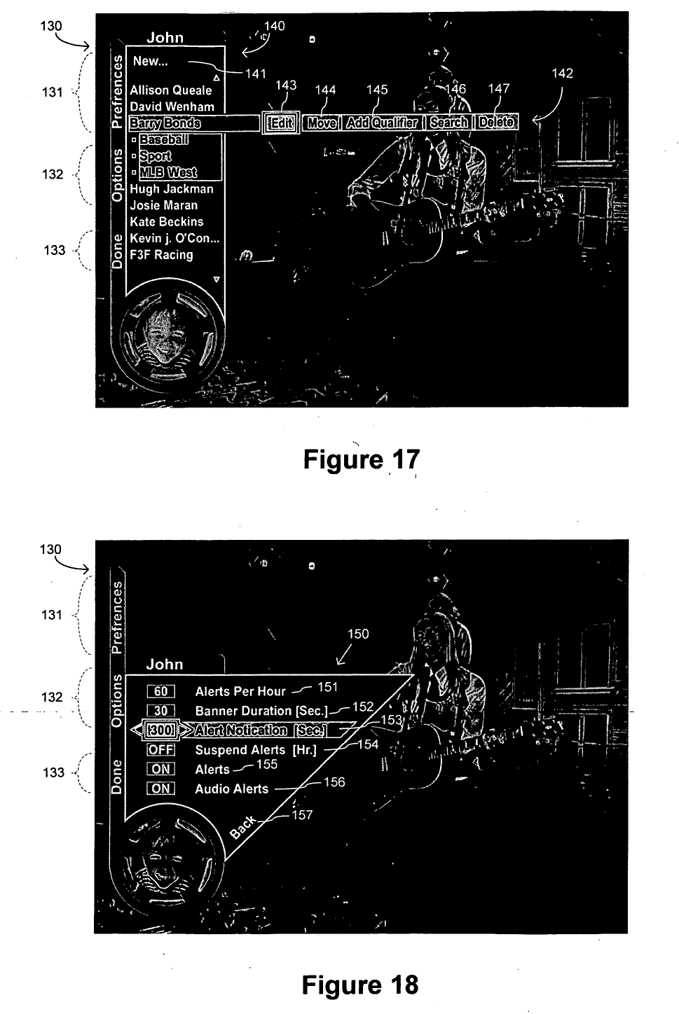

FIGS. 11-18 show user interfaces providing the feature set and navigation paths of FIG. 8. FIG. 11 shows a personalized content listing user interface 120 that is displayed in response to a user command to show a personalized list of available content. At the left of the user interface 120 is a content type navigation tool 121 that allows the user to select among different types of content that may be displayed in the list. In the preferred embodiment, the navigation tool uses a three dimensional rotational metaphor in which identifiers of different content types 122 are displayed as if located on the surface of a transparent three dimensional object that may be rotated so as to bring each of the content types 122 to the foreground in succession. Rotation may be controlled through operation of up and down directional buttons on the remote control. As seen in the figure, the content types 122 include Now (current programs), Later (future programs), VOD (video on demand programs) and HD (high definition programs). Rotation of a content type to the foreground causes a set of program listings selected in accordance with the viewer's preferences to be displayed in a list 123 that provides the titles, networks and times of programs. The list defaults to a Now selection (i.e. programs that are currently airing) as shown in FIG. 11. FIGS. 12, 13 and 14 show the content type navigation tool in alternate positions that select a Later (i.e. upcoming) program list, a VOD (video on demand) program list, and an HD (high definition) program list. In each instance, the user interface indicates the type of content displayed in the list and displays an indication of the user (John) whose viewing preferences have been used to generate the list. A clock symbol next to a program in the list indicates that an alert has been set for that program. The alert will cause the display of the user interface of FIG. 9 at a time in advance of the air time of the program.

The content displayed in the list is selected based on affinity calculations using the characteristic sets of the available program metadata and user's viewing preferences. This allows the viewer to display a list of the current programs that are most likely to be of interest to the viewer, eliminating the need for the viewer to scroll through or search all current listings. It is preferred that this list is restricted to a small number of listings and contained within an area near the border of the screen that does not obstruct the current video in the center of the screen. The viewer can navigate between the content type navigation tool 121 and the list 123 by operating the left and right directional buttons of the remote control. The viewer can move an indicator among programs in the list by operating the up and down buttons of the remote control. Pressing select while the indicator is located on a program in the list 123 causes the device to change to the channel of that program if it is a current program, or to set an alert for that program if it is a future program.

To the right of the program listings is an ancillary content window 124. The window 124 typically displays an image, animation, video preview or live video corresponding to a program in the list to which the user has navigated the indictor. Beneath the image is a crawl 125 that displays characteristics from the metadata of that program. The characteristics displayed in the crawl may be selected based on the user's viewing preferences. The display further includes a time bar 126 showing the progress of the program and the start and end time of the program. As seen in FIGS. 12-14, a similar format is used for other types of content.

FIG. 15 shows the user interface of FIG. 11 after the user has provided a command to display description information 127 for a program in the list on which the indicator has been position. The command to display the description information 127 may be supplied by operating a display key on the remote control or navigating to the right after positioning the indicator on the program in the list. Both the program list and the description are located near the borders of the screen so as not to obscure video at the center of the screen. The elements and operation of the description display 127 is substantially the same as that described with respect to FIG. 9.

FIG. 16 shows the user interface after the user has selected a characteristic from among the listed categories and keywords. In the preferred embodiment, an animation shows the selected characteristic moving from the list of characteristics across the screen to an area labeled with the current user's name (John), signifying the addition of that characteristic to the user's preferences.

An additional selection on the content type navigation tool 122 is a “search” option. Navigation to and selection of the search option takes the user to preference and option configuration portions of the user interface. The preference portion of the user interface is shown in FIG. 17 and the options portion of the user interface is shown in FIG. 18.

Referring to FIG. 17, the user interface includes a navigation bar 130 listing the navigation choices “preferences” 131, “options” 132 and “done” 133. The user may move an indicator among these choices using up and down directional keys on the remote control. Movement of the indicator to the preferences choice invokes a preferences user interface 140 as shown in FIG. 17, while moving the indicator to the options choice invokes an options user interface 150 as shown in FIG. 18. The user may navigate between the navigation bar 130 and the preferences user interface 140 or the options user interface 150 using the left and right directional keys of the remote control. Movement of the indicator to the “done” choice 133 enables the user to select the done choice, thereby exiting the preference and option configuration portion of the user interface and returning the user to the personalized content listings of FIGS. 11-16.

The preferences user interface 140 enables the user to edit a list of characteristics (keywords and categories) that are used as filtering criteria for populating the personalized content lists of FIGS. 11-16. The preferences user interface 140 presents the current set of characteristics as an ordered list, through which the user may navigate an indicator using up and down directional keys of the remote control. A “new” option 141 at the top of the list may be selected to manually create a new characteristic. When new is selected, a keyboard is displayed, allowing the user to navigate among and select letters of the alphabet to type in a new characteristic. The preferred embodiment enables the user to enter any characteristic and also provides an auto-complete or similar feature to indicate predefined categories and keywords containing the root that the user has typed.

When the indicator is navigated to an existing characteristic, a tool bar 142 is displayed in conjunction with the characteristic. The tool bar presents the user with choices to edit 143, move 144, add qualifier 145, search 146 and delete 147 the corresponding characteristic. The user may navigate an indicator among the choices in the tool bar 142 using the left and right directional keys of the remote control. A particular tool may be selected by moving the navigator to that tool and then pressing an enter key on the remote control.

Selection of the edit tool 143 allows the user to edit the corresponding characteristic (e.g. change the spelling). This is done using a keyboard that is displayed to the user in a manner similar to creation of a new characteristic.

Selection of the move tool 144 allows the user to move the characteristic up or down within the characteristics list by operating the up and down directional buttons of the remote control. The position of a characteristic within the list represents its relative importance to the user and thus is used to weight that characteristic relative to other characteristics for purposes of selecting programs to populate the personalized content list or creating a schedule of program alerts.

Selection of the add qualifier tool 145 allows the user to specify a keyword to accompany a category in the list or a category to accompany a keyword in the list. The keyword or category is specified using a keyboard display in a manner similar to the creation of a new characteristic. The exemplary user interface of FIG. 17 shows an example of the categories “Baseball,” “Sport” and “MLB West” as qualifiers of the keyword “Barry Bonds.” The specification of a category/keyword qualified pair characteristic indicates that both the category and the keyword must be present in the metadata of a program in order for that program to match the characteristic. This enables the user to more precisely specify a type of subject matter of interest. Navigation to a qualifier associated with a characteristic (e.g., Baseball in FIG. 17) presents the user with a tool bar (not shown) that enables the user to edit or delete the qualifier.

Selection of the search tool 146 invokes a search function that identifies programs matching the selected characteristic and presents a list of those programs to the user. This enables the user to determine the accuracy with which the characteristic represents his interests by viewing a list of search results based on that characteristic.

Selection of the delete tool 147 enables the user to delete the selected characteristic from the set of characteristics.

Referring to FIG. 18, the user interface includes the navigation bar 130 listing navigation choices, and a set of options tools 150 that the user may navigate among to configure various options including the number of alerts to be generated per hour 151, the duration of the alert banner 152, the number of seconds in advance of a program to provide the alert 153, the option to suspend alerts for a specified period of time 154, the option to toggle alerts on and off 155, and the option to toggle an audio alert signal on and off 156. The user may navigate among these tools by moving an indicator using the up and down directional keys of the remote control, and may operate the tools on which the indicator is located using the left and right directional keys of the remote control. The user may also navigate to a “back” selection 157 which returns the indicator to the navigation bar 130.

As indicated above, the user interface is user-specific with respect to the preferences used to identify content and the options configured for the system. Although not shown in the figures, the user interface of the preferred embodiment also supports multiple users and enables switching users so that a different user's options and preferences are used to personalize the features of the user interface.

A preferred feature of the user interface of FIGS. 11-18 is that it provides displays of personalized viewing lists for various content types, navigation among the various content types, display of a description of a program, the addition of preferences to a viewer profile based on characteristics of the displayed description, and configuration tools for preferences and options, and does so concurrently with the display of video content on the screen within relatively small areas near the borders of the screen. Therefore all the features of the user interface can be used concurrently with viewing of a program. Further, the user interface at all times provides an indication of the user's “location,” that is, the current active user, and the position of the user in the navigational path of the user interface.

While the discussion of the preferred embodiment refers generally to programs, the user interfaces of the preferred embodiment provide listings, descriptions, alerts, and preference updates for both programs and program segments in accordance with the available program and program segment metadata.

The embodiments described above assume that the user interfaces are produced by a device such as a set top box or digital video recorder that is controlled by the viewer using a conventional infrared or RF remote control. However in other implementations the viewer control signals may be provided to the device in other manners. For example, the video receiver device may be networked to a personal computer or personal digital assistant, allowing commands to be entered using an interface generated by the computer.

While the aforementioned embodiments are described as being implemented in a video receiver device such as a set top box, digital video recorder or home media server, further embodiments may be implemented on other platforms. For example, devices that typically do not receive multiple channels of video data, such as personal computers, personal digital assistants and cell phones, can be used as platforms for implementing many of the features described above. In one alternative embodiment, these and other platforms may support a navigation system that displays personalized listings of programs and program segments, and that provides related features such as scheduling and generating alerts, and updating preferences to include a characteristic selected from among the characteristics of a program for which a description is displayed. Additional capabilities related to the receipt of video, such as recording and scheduling of recording, displaying user interfaces over video content, and tuning to programs or requesting transmission of programs, may be implemented on such platforms to the extent that receipt of video signals is available.

The devices, features and processing described herein are not exclusive of other devices, features and processing, and variations and additions may be implemented in accordance with the particular objectives to be achieved. For example, a system as described above may be integrated with other systems not described herein to provide further combinations of features, to operate concurrently on the same computing devices, or to serve other types of users. Thus, while the embodiments illustrated in the figures and described above are presently preferred for various reasons as described herein, it should be understood that these embodiments are offered by way of example only. The invention is not limited to a particular embodiment, but extends to various modifications, combinations, and permutations that fall within the scope of the claims and their equivalents.

1. A method in a programmable device for defining a set of viewing preferences of a video program viewer, comprising:
receiving a first user input from a viewer of a video program;
displaying a set of characteristics of the video program in superposition over the video program in response to the first user input;
receiving second user input from the viewer to select one of the displayed characteristics; and
adding the selected characteristic to a set of characteristics representing viewing preferences of the viewer.

2. The method claimed in claim 1, wherein the set of characteristics of the video program comprises one or more of keywords and categories contained in metadata corresponding to the video program.

3. The method claimed in claim 1, wherein the second user input comprises navigation commands to navigate an indicator to a particular one of the displayed characteristics.

4. The method claimed in claim 3, wherein the second user input further comprises a selection command to select a characteristic to which the indicator has been navigated.

5. A method in a programmable device for defining a set of viewing preferences of a video program viewer, comprising:
automatically displaying an alert that informs the viewer of the availability of a video program, the alert being displayed in superposition over a displayed video program;
receiving a first user input from a viewer of the video program;
displaying a set of characteristics of the video program in superposition over the displayed video program in response to the first user input;
receiving second user input from the viewer to select one of the displayed characteristics; and
adding the selected characteristic to a set of characteristics representing viewing preferences of the viewer.

6. The method claimed in claim 5, wherein the set of characteristics of the video program comprises one or more of keywords and categories contained in metadata corresponding to the video program.

7. The method claimed in claim 5, wherein the second user input comprises navigation commands to navigate an indicator to a particular one of the displayed characteristics.

8. The method claimed in claim 7, wherein the second user input further comprises a selection command to select a characteristic to which the indicator has been navigated.

9. A method in a programmable device for presenting a personalized list of video programs to a video program viewer, comprising:
receiving a first user input from a viewer of a video program;
selecting a subset of video programs of a predefined content type from among a set of video programs for which descriptive metadata is possessed in accordance with a set of viewer preferences;
displaying program listings for the subset of video programs in superposition over the video program in response to the first input;
receiving a second user input from the viewer;
displaying a set of characteristics of a selected video program in the displayed program listings in superposition over the video program in response to the second user input;
receiving third user input from the viewer to select one of the displayed characteristics; and
adding the selected characteristic to a set of characteristics representing viewing preferences of the viewer.

10. The method claimed in claim 9, wherein the set of characteristics of the selected video program comprises one or more of keywords and categories contained in metadata corresponding to the video program.

11. The method claimed in claim 9, wherein the second user input comprises navigation commands to navigate an indicator to a particular one of the displayed program listings.

12. The method claimed in claim 9, wherein the third user input comprises navigation commands to navigate an indicator to a particular one of the displayed characteristics.

13. The method claimed in claim 12, wherein the third user input further comprises a selection command to select a characteristic to which the indicator has been navigated.

14. The method claimed in claim 9, wherein the predefined content type is currently available video programs.

15. The method claimed in claim 9, wherein the predefined content type is upcoming video programs.

16. A method in a programmable device for presenting a personalized list of video programs to a video program viewer, comprising:
receiving a first user input from a viewer of a video program;
selecting a first subset of video programs of a first predefined content type from among a set of video programs for which descriptive metadata is possessed in accordance with a set of viewer preferences;
displaying program listings for the first subset of video programs in superposition over the video program in response to the first input;
receiving a second user input from the viewer;
selecting a second subset of video programs of a second predefined type from among a set of video programs for which descriptive metadata is possessed in accordance with the set of viewer preferences;
displaying program listings for the second subset of video programs in place of the program listings for the first subset of video programs in response to the second user input.

17. The method claimed in claim 16, wherein the second user input comprises navigation commands to navigate an indicator to a particular one of available content types displayed in conjunction with the displayed program listings.

18. The method claimed in claim 17, wherein the second user input further comprises a selection command to select a content type to which the indicator has been navigated.

19. The method claimed in claim 16, wherein the first predefined content type is one of currently available video programs and upcoming video programs.

20. The method claimed in claim 16, wherein the first predefined content type is one of currently available video programs and upcoming video programs.

21. A method in a programmable device for specifying video program characteristics of interest to a viewer, comprising:
receiving first user input from a viewer;
displaying a list of characteristics representing a set of viewer preferences in response to the first user input;
receiving second user input from the viewer selecting a characteristic in the list; and
receiving third user input from the viewer moving the selected characteristic to a new position in the list, wherein the positions of the characteristics in the list represent their relative importance to the viewer.
